(19) United States
(12) Patent Application Publication
(10) Pub. No.: US 2019/0168997 A1
(43) Pub. Date: Jun. 6, 2019

(54) ELEVATOR GROUP MANAGEMENT FOR OCCUPANT EVACUATION

(71) Applicant: Otis Elevator Company, Farmington, CT (US)

(72) Inventors: Tarique Faruki, Florence, SC (US); Bennie J. Murah, Timmonsville, SC (US)

(21) Appl. No.: 15/830,070

(22) Filed: Dec. 4, 2017

(51) Int. Cl. B66B 5/02; B66B 1/28

(52) U.S. Cl. CPC B66B 5/021; B66B 2201/40; B66B 1/28

(57) ABSTRACT

A method of operating a building elevator system includes determining that an evacuation call is active for an evacuation floor serviced by a first elevator group. A transfer floor serviced by the first elevator group is set as an evacuation discharge floor of the first elevator group. A second elevator group is requested to enter an evacuation mode of operation. The second elevator group is operable to service the transfer floor and a discharge floor. The transfer floor is set as the evacuation floor of the second elevator group. Control of the first elevator group and the second elevator group is coordinated to evacuate one or more occupants from the evacuation floor serviced by the first elevator group to the discharge floor serviced by the second elevator group.

### BACKGROUND

The subject matter disclosed herein relates generally to the field of elevator systems, and specifically to a method and apparatus for coordinating the operation of multiple elevator cars.

Commonly, very tall buildings (ex: high rise or sky scrapers) require sky lobbies or transfer floors, which are intermediate interchange (i.e. transfer) floors where people may transfer from an elevator serving an upper portion of the building to an elevator serving a lower portion of the building. Some elevator systems can be operable during an emergency to evacuate occupants between an evacuation floor and a discharge floor. However, if travel between the evacuation floor and the discharge floor is impeded, occupants may have to use the stairs instead.

### BRIEF DESCRIPTION

According to one embodiment, a method of operating a building elevator system includes determining that an evacuation call is active for an evacuation floor serviced by a first elevator group. A transfer floor serviced by the first elevator group is set as an evacuation discharge floor of the first elevator group. A second elevator group is requested to enter an evacuation mode of operation. The second elevator group is operable to service the transfer floor and a discharge floor. The transfer floor is set as the evacuation floor of the second elevator group. Control of the first elevator group and the second elevator group is coordinated to evacuate one or more occupants from the evacuation floor serviced by the first elevator group to the discharge floor serviced by the second elevator group.

In addition to one or more of the features described above or below, or as an alternative, further embodiments may include where the evacuation floor serviced by the first elevator group is unreachable by the second elevator group.

In addition to one or more of the features described above or below, or as an alternative, further embodiments may include where requesting the second elevator group to enter the evacuation mode of operation is performed based on determining that the first elevator group is inhibited from traveling to the discharge floor.

In addition to one or more of the features described above or below, or as an alternative, further embodiments may include where determining that the first elevator group is inhibited from traveling to the discharge floor is based on detecting a degraded hoistway condition.

In addition to one or more of the features described above or below, or as an alternative, further embodiments may include monitoring one or more conditions of the discharge floor, setting the evacuation discharge floor of the second elevator group to an alternate discharge floor based on detecting one or more degraded conditions at the discharge floor, and restricting travel of the second elevator group between the alternate discharge floor and the discharge floor.

In addition to one or more of the features described above or below, or as an alternative, further embodiments may include changing the evacuation discharge floor of one or more elevator cars of the first elevator group to a secondary transfer floor.

In addition to one or more of the features described above or below, or as an alternative, further embodiments may include where the evacuation mode of operation prioritizes travel between the transfer floor and the discharge floor over one or more requests received from one or more elevator call buttons between the transfer floor and the discharge.

According to another embodiment, control system of a building elevator system includes a processor and a memory including computer-executable instructions that, when executed by the processor, cause the processor to perform operations. The operations include determining that an evacuation call is active for an evacuation floor serviced by a first elevator group, setting a transfer floor serviced by the first elevator group as an evacuation discharge floor of the first elevator group, and requesting a second elevator group to enter an evacuation mode of operation, the second elevator group operable to service the transfer floor and a discharge floor. The operations also include setting the transfer floor as the evacuation floor of the second elevator group and coordinating control of the first elevator group and the second elevator group to evacuate one or more occupants from the evacuation floor serviced by the first elevator group to the discharge floor serviced by the second elevator group.

According to another embodiment, a computer program product is tangibly embodied on a computer readable medium. The computer program product includes instructions that, when executed by a processor, cause the processor to perform operations. The operations include determining that an evacuation call is active for an evacuation floor serviced by a first elevator group, setting a transfer floor serviced by the first elevator group as an evacuation discharge floor of the first elevator group, and requesting a second elevator group to enter an evacuation mode of operation, the second elevator group operable to service the transfer floor and a discharge floor. The operations also include setting the transfer floor as the evacuation floor of the second elevator group and coordinating control of the first elevator group and the second elevator group to evacuate one or more occupants from the evacuation floor serviced by the first elevator group to the discharge floor serviced by the second elevator group.

Technical effects of embodiments of the present disclosure include elevator group control for occupant evacuation.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 illustrates a schematic view of an elevator assembly, in accordance with an embodiment of the disclosure;

FIG. 2 illustrates a schematic view of a building elevator system, in accordance with an embodiment of the disclosure;

FIG. 3 illustrates a schematic view of a building elevator configuration, in accordance with an embodiment of the disclosure;

FIG. 4 illustrates a schematic view of a building elevator configuration, in accordance with an embodiment of the disclosure; and

FIG. 5 is a flow chart of method of operating a building elevator system, in accordance with an embodiment of the disclosure.

### DETAILED DESCRIPTION

A detailed description of one or more embodiments of the disclosed apparatus and method are presented herein by way of exemplification and not limitation with reference to the Figures.

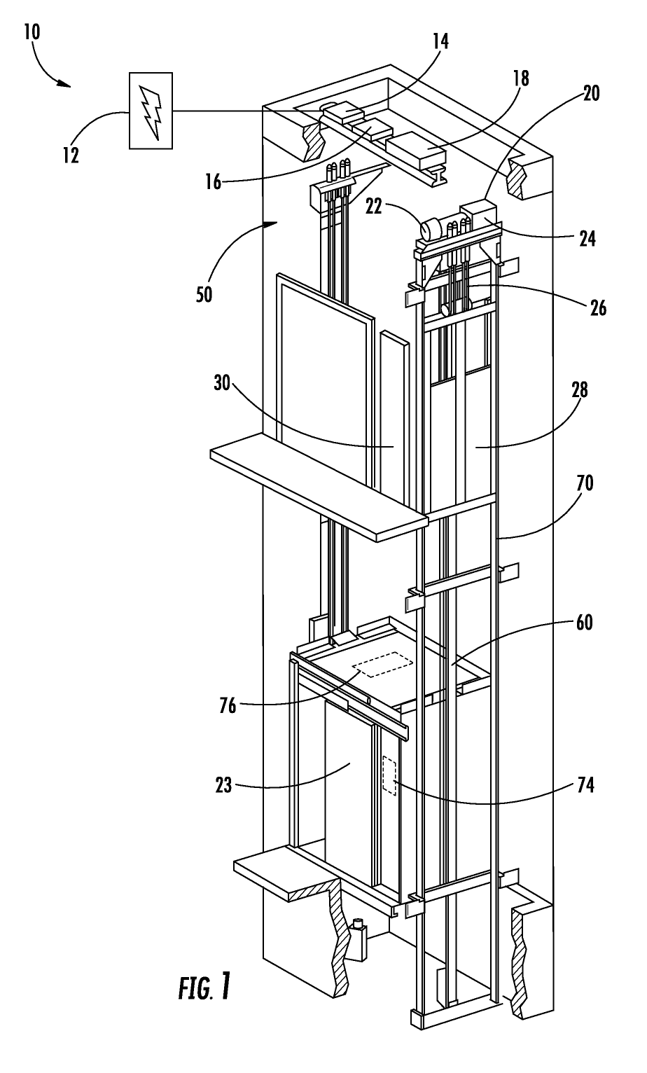

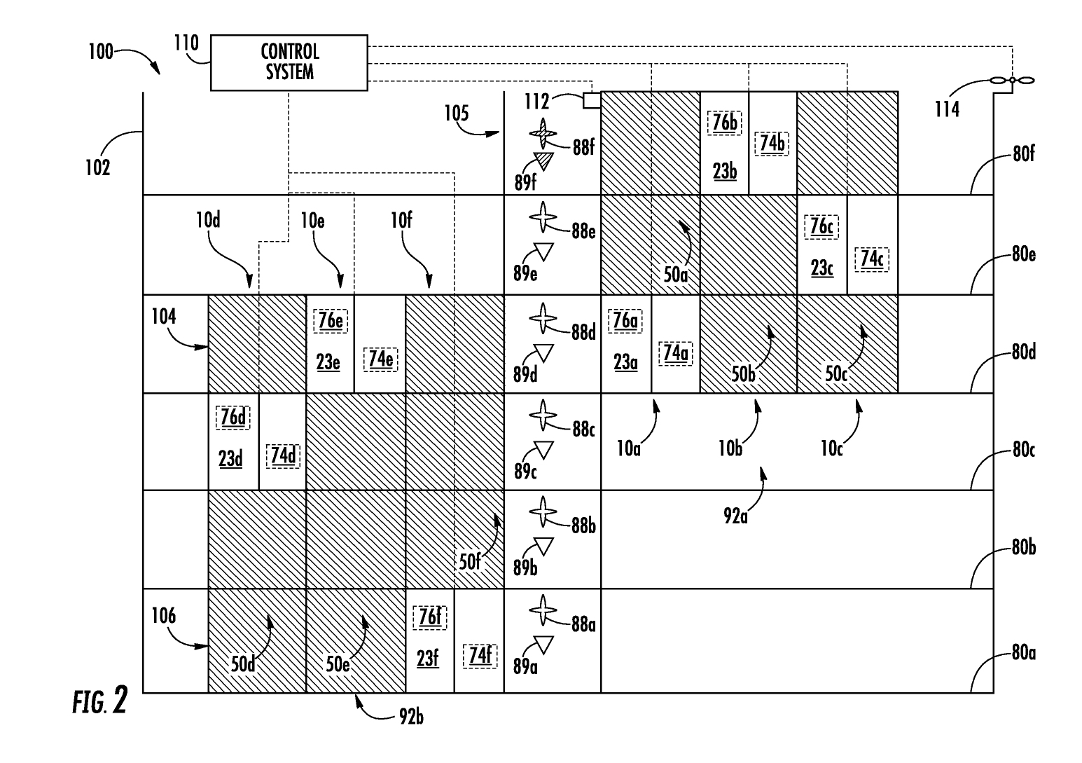

FIG. 1 shows a schematic view of an elevator assembly 10, in accordance with an embodiment of the disclosure. FIG. 2 shows schematic view of a building elevator system 100, in accordance with an embodiment of the disclosure. With reference to FIG. 1, the elevator assembly 10 includes an elevator car 23 configured to move vertically upward and downward within a hoistway 50 along a plurality of car guide rails 60. The elevator assembly 10 also includes a counterweight 28 operably connected to the elevator car 23 via a pulley system 26. The counterweight 28 is configured to move vertically upward and downward within the hoistway 50. The counterweight 28 moves in a direction generally opposite the movement of the elevator car 23, as is known in conventional elevator assemblies. Movement of the counterweight 28 is guided by counterweight guide rails 70 mounted within the hoistway 50.

The elevator assembly 10 also includes a power source 12. The power is provided from the power source 12 to a switch panel 14, which may include circuit breakers, meters, etc. From the switch panel 14, the power may be provided directly to the drive unit 20 through the controller 30 or to an internal power source charger 16, which converts alternating current (AC) power to direct current (DC) power to charge an internal power source 18 that requires charging. For instance, an internal power source 18 that requires charging may be a battery, capacitor, or any other type of power storage device known to one of ordinary skill in the art. Alternatively, the internal power source 18 may not require charging from the external power source 12 and may be a device such as, for example a gas powered generator, solar cells, hydroelectric generator, wind turbine generator or similar power generation device. The internal power source 18 may power various components of the elevator assembly 10 when an external power source is unavailable. The drive unit 20 drives a machine 22 to impart motion to the elevator car 23 via a traction sheave of the machine 22. The machine 22 also includes a brake 24 that can be activated to stop the machine 22 and elevator car 23. As will be appreciated by those of skill in the art, FIG. 1 depicts a machine room-less elevator assembly 10, however the embodiments disclosed herein may be incorporated with other elevator assemblies that are not machine room-less or that include any other known elevator configuration. In addition, hydraulic elevator systems, elevator systems having more than one independently operating elevator car in each elevator shaft and/or ropeless elevator systems may also be used. In one embodiment, the elevator car may have two or more compartments.

The controller 30 is responsible for controlling the operation of the elevator assembly 10. The controller 30 is tied to a control system 110 (FIG. 2), which is responsible for controlling multiple elevator assemblies and will be discussed below. The controller 30 may also determine a mode (motoring, regenerative, near balance) of the elevator car 23. The controller 30 may use the car direction and the weight distribution between the elevator car 23 and the counterweight 28 to determine the mode of the elevator car 23. The controller 30 may adjust the velocity of the elevator car 23 to reach a target floor. The controller 30 may include a processor and an associated memory. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

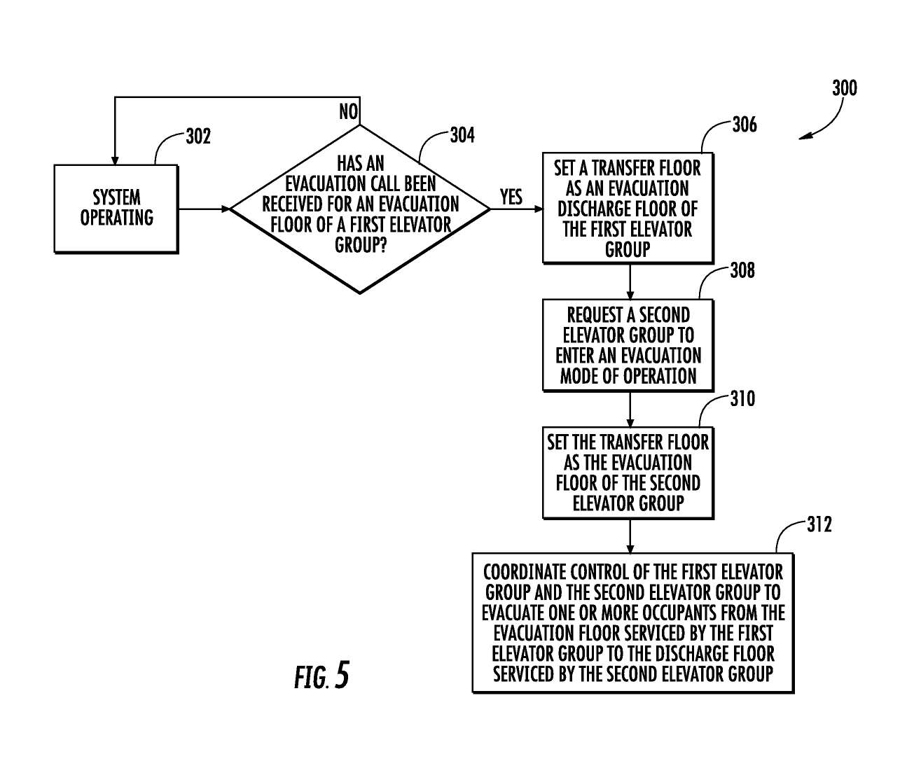

As seen in FIG. 2, a building elevator system 100 within a building 102 may include multiple different individual elevator assemblies 10a-10f. The elevator assemblies 10 may be divided up into two or more elevator groups 92a, 92b. In very tall buildings (ex: high rise and skyscrapers) with a large number of floors 80a-80f, multiple elevator groups 92a, 92b may be used to get occupants to desired destinations faster and more efficiently. Multiple elevator groups 92a, 92b may also exist in shorter buildings for various other reasons including but not limited to, efficiency and/or structural constraints. FIG. 2 includes a first elevator group 92a and a second elevator group 92b. Floor coverage of each elevator group 92a, 92b typically overlaps at a transfer floor 104 (ex: sky lobby), so that occupants may disembark one of the elevator groups 92a, 92b and enter another. Buildings may have multiple transfer floors 104 including a first transfer floor 104a and a second transfer floor 104b (FIG. 4). As seen in FIG. 2, the floor coverage of the first elevator group 92a overlaps the floor coverage of the second elevator group 92b at floor 80d, which is considered the transfer floor 104. Each elevator group 92a, 92b may have one or more elevator assemblies 10a-10f having elevator cars 23a-23f in an elevator hoistway 50a-50d. In an embodiment, the first elevator group 92a is at a higher elevation than the second elevator group 92b in the building 102. That is, the first elevator group 92a serves floors 80d-80f and the second elevator group 92b serves floors 80a-80d. In order for a passenger from floors 80a-80c to reach floors 80e-80f, they would need to transfer from second elevator group 92b to first elevator group 92a at floor 80d. While the building 102 of FIG. 2 is depicted with six floors, buildings may have any desired number of floors. Moreover, the second elevator group 92b and first elevator group 92a may each serve any number of independent and overlapping floors as desired.

Each floor 80a-80f in the building 102 of FIG. 2 may have an elevator call button 89a-89f and an evacuation alarm 88a-88f The elevator call button 89a-89f sends an elevator call to the control system 110. The elevator call button 89a-89f may be a push button and/or a touch screen and may be activated manually or automatically. For example, the elevator call button 89a-89f may be activated by a building occupant pushing the elevator call button 89a-89f The elevator call button 89a-89f may also be activated by voice recognition or a passenger detection mechanism in the hallway, such as, for example a weight sensing device, a visual recognition device, and a laser detection device. The evacuation alarm 88a-88f may be activated or deactivated either manually or automatically through an alarm system (not depicted) operable to alert building occupants of conditions and threats relevant to elevator operation (e.g., fire, chemical, biological agents or smoke near points of elevator entry/egress). If the evacuation alarm 88a-88f is activated, an evacuation call is sent to the control system 110 indicating the respective floor 80a-80f where the evacuation alarm 88a-88f was activated. In the example of FIG. 2, an evacuation alarm 88f is activated, and floor 80f is the evacuation floor 105.

In building 102 having a second elevator group 92b and a first elevator group 92a, in the case of an evacuation, elevator cars 23a-23c of the first elevator group 92a may carry occupants to the transfer floor 104 for evacuation, and the control system 110 may send elevator cars 23d-23f of the second elevator group 92b to the transfer floor 104 to receive the occupants exiting the elevator cars 23a-23c of the first elevator group 92a and, thereby, return them to a discharge floor 106, e.g., the ground floor (or any other desired evacuation floor) for evacuation. In the example of FIG. 2, the discharge floor 106 may be floor 80a, such as a lobby of building 102. In one embodiment, the discharge floor 106 may be any desired floor that allows people to evacuate the building or otherwise offers people safety (e.g., a floor with a refuge space).

The control system 110 is operably connected to the controller 30 (see FIG. 1) of each elevator assembly 10. The control system 110 is configured to the control and coordinate operation of multiple elevator groups 92a, 92b. The control system 110 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The elevator groups 92a, 92b may also include a notification device 74 as seen in FIG. 1, and each elevator group 92a, 92b may include a notification device 74a-74f as seen in FIG. 2. The notification device 74a-74f may be located within the individual elevator cars 23a-23f, at each floor 80a-f, and/or on the transfer floor 104. The notification device 74a-74f is in operative communication with the control system 110. The notification device 74a-74f can be configured to provide transfer instructions to occupants. For example, the transfer instructions may describe where on the transfer floor 104 to board an elevator car 23d-23f of the second elevator group 92b when the occupants are disembarking an elevator car 23a-23c of the first elevator group 92a. The notification device 74a-74f may provide transfer instructions in audible and/or visual form.

The elevator assemblies 10a-10f may also include a sensor system 76 configured to detect a number of occupants in a particular elevator car 23, as seen in FIG. 1. The sensor system 76 is also seen in FIG. 2, as sensor systems 76a-76f The sensor system 76 is in operative communication with the control system 110. The sensor system 76 may use a variety of sensing mechanisms such as, for example, a visual detection device, a weight detection device, a laser detection device, a door reversal monitoring device, a thermal image detection device, and a depth detection device. The visual detection device may be a camera that utilizes visual recognition to identify and count individual passengers. The weight detection device may be a scale to sense the amount of weight in an elevator car 23 and then determine the number of passengers from the weight sensed in combination with one or more other sensing mechanisms, such as a door detector. The laser detection device may detect how many passengers walk through a laser beam to determine the number of passengers in the elevator car 23. Similarly, a door reversal monitoring device also detects passengers entering the car so as not to close the elevator door on a passenger and thus may be used to determine the number of passengers in the elevator car 23. The thermal detection device may be an infrared or other heat sensing camera that utilizes detected temperature to identify and count individual passengers in combination with other image-based detection for headcounts, facial detection, and/or other sensing techniques. The depth detection device may be a 2-D, 3-D or other depth/distance detecting camera that utilizes detected distance to an object to identify and count individual passengers. As may be appreciated by one of skill in the art, in addition to the stated methods, additional methods may exist to sense the number of passengers and one or any combination of these methods may be used to determine the number of passengers in the elevator car. In addition or in place of counting the number of occupants, the control system 110 may detect the amount of free and/or occupied space in the elevator car 23 and use this data instead of passenger count. In some embodiments, the control system 110 may estimate the number of occupants based upon the amount of free and/or occupied space (along with weight data) in the elevator car 23.

Determining the number of occupants in an elevator car 23a-23c of the first elevator group 92a approaching the transfer floor may help the control system 110 determine how many elevators cars 23d-23f to send to the transfer floor 104 from the second elevator group 92b. The control system 110 is configured to determine the number of occupants in an elevator car 23a-23c of the first elevator group 92a so as to send the appropriate number of elevators cars 23d-23f from the second elevator group 92b to the transfer floor 104, which can expedite transferring passengers between the two elevator groups 92a, 92b.

In embodiments, the control system 110 can determine one or more conditions of the building 102 to assist in determining whether travel of elevator cars 23a-23c of the first elevator group 92a can reach a desired floor. For example, the control system 110 can monitor a building sway sensor 112, a wind sensor 114, and/or other environmental sensors. The sway sensor 112 can monitor motion magnitude and/or frequency of motion of the building 102, for instance due to seismic activity or wind. The wind sensor 114 may assist in quantifying the source of motion of the building 102 and the intensity level of a building sway event. The sway sensor 112 may be accelerometer based, pendulum based, or optically based, for example, to determine the magnitude and frequency of movement of a portion of the building 102.

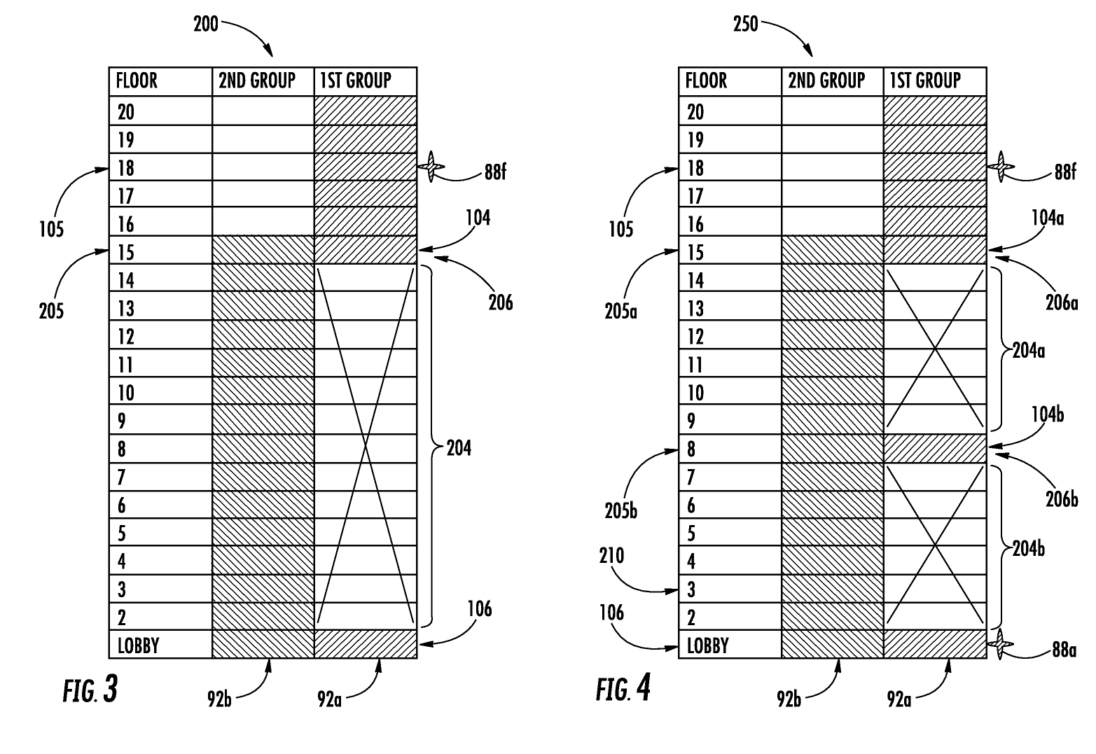

In some embodiments, the first elevator group 92a is an express elevator system that is accessible from the discharge floor 106 under normal operating conditions, as depicted in the example building elevator configuration 200 of FIG. 3 and the building elevator configuration 250 of FIG. 4. The building elevator configuration 200 includes an inaccessible region of floors 204 that prevent entrance/egress in the elevators of the first elevator group 92a at floors between the discharge floor 106 and the transfer floor 104. The building elevator configuration 250 includes a first region of inaccessible floors 204a that prevents entrance/egress in the elevators of the first elevator group 92a at floors between a first transfer floor 104a (e.g., equivalent to the transfer floor 104 of FIG. 3) and a second transfer floor 104b, and a second region of inaccessible floors 204b that prevents entrance/egress in the elevators of the first elevator group 92a at floors between the second transfer floor 104b and the discharge floor 106. It will be understood that numerous other elevator groupings and configurations are contemplated. In the example of FIG. 4, occupant transfers between the first elevator group 92a and the second elevator group 92b can occur at either the first transfer floor 104a or the second transfer floor 104b. The second elevator group 92b may also support an alternate discharge floor 210 that, for instance, may have access to outside of the building 102, such as through a stairway, an escalator system, a sky bridge, or other such structure. The alternate discharge floor 210 may be preferred if there is an evacuation alarm 88a active or other such degraded condition detected at the discharge floor 106. The alternate discharge floor 210 may be selected based on environmental or other current conditions such that the alternate discharge floor is selected for use as needed. Notably, in the example of FIG. 4, the alternate discharge floor 210 is inaccessible from the first elevator group 92a due to alignment with the second region of inaccessible floors 204.

When the second elevator group 92b is configured in an evacuation mode of operation to support evacuation through the first elevator group 92a, the transfer floor 104 becomes an evacuation discharge floor 206 of the first elevator group 92a and an evacuation floor 205 of the second elevator group 92b. Such an event could put the second elevator group 92b into evacuation even if it was not in evacuation initially. Similarly, if multiple transfer floors 104a, 104b are supported, when the second elevator group 92b is configured in an evacuation mode of operation to support evacuation through the first elevator group 92a, the first transfer floor 104a can be a first evacuation discharge floor 206a of the first elevator group 92a and a first evacuation floor 205a of the second elevator group 92b. Similarly, the second transfer floor 104b can be a second evacuation discharge floor 206b of the first elevator group 92a and a second evacuation floor 205b of the second elevator group 92b.

Referring now to FIG. 5, while referencing components of FIGS. 1-4, FIG. 5 shows a flow chart of method 300 of operating a building elevator system 100, in accordance with an embodiment of the disclosure which may be used for various configurations, such as building elevator configurations 200, 250. The method 300 can include additional steps beyond those depicted in FIG. 5 and some steps may be performed in an alternate order.

At block 302, the building elevator system 100 is under normal operation. Under normal operation, the control system 110 controls the first elevator group 92a and the second elevator group 92b according to normal dispatching priorities (e.g., non-evacuation mode). As mentioned above, the floor coverage of the first elevator group 92a overlaps the floor coverage of the second elevator group 92b by at least one transfer floor 104, as seen in FIG. 2. In the example of FIG. 2, the transfer floor 104 is floor 80d. In the example of FIG. 4, there are multiple transfer floors 104, including a first transfer floor 104a and a second transfer floor 104b, in some configurations, such as the building elevator configuration 250.

At block 304, the control system 110 detects if an evacuation call has been received. At block 304, based determining that an evacuation call is active for an evacuation floor 105 serviced by a first elevator group 92a, the method 300 continues to block 306; otherwise, the method 300 returns to block 302. At block 306, the control system 110 sets a transfer floor 104 serviced by the first elevator group 92a as an evacuation discharge floor 206 of the first elevator group 92a.

At block 308, the control system 110 requests a second elevator group 92b to enter an evacuation mode of operation, where the second elevator group 92b is operable to service the transfer floor 104 and a discharge floor 106. Requesting the second elevator group 92b to enter the evacuation mode of operation can be performed based on determining that the first elevator group 92a is inhibited from traveling to the discharge floor 106, for instance, based on a degraded hoistway condition. For example, the control system 110 can detect a sway condition of the first elevator group 92a, compare the sway condition to a sway limit, and determine that the first elevator group 92a is inhibited from traveling between the transfer floor 104 and the discharge floor 106 based on a result of comparing the sway condition to the sway limit. The sway limit can be defined in terms of a sway frequency and/or magnitude. For instance, if the resonant frequency of the first elevator group 92a would result in a risk of component contact as elevator cars 23a-23c traverse between the evacuation floor 105 and the discharge floor 106, then direct travel to the discharge floor 106 can be inhibited, resulting in a mode transition for the second elevator group 92b to enter the evacuation mode of operation even though no floors 80a-80d directly serviced by the second elevator group 92b have a corresponding evacuation call. Other examples include detected seismic activity responsive to a seismic sensor, a counterweight misalignment condition, and other such conditions. The evacuation mode of operation can prioritize travel between the transfer floor 104 and the discharge floor 106 over one or more requests received from one or more elevator call buttons 89b-89c between the transfer floor 104 and the discharge floor 106. For example, rather than servicing elevator call requests between the transfer floor 104 and discharge floor 106, the control system 110 stops at the transfer floor 104 or the discharge floor 106 while evacuation is active.

At block 310, the control system 110 sets the transfer floor 104 as the evacuation floor 205 of the second elevator group 92b. The evacuation floor 105 serviced by the first elevator group 92a may be unreachable by the second elevator group 92b. At block 312, the control system 110 coordinates control of the first elevator group 92a and the second elevator group 92b to evacuate one or more occupants from the evacuation floor 104 serviced by the first elevator group 92a to the discharge floor 106 serviced by the second elevator group 92b.

In embodiments, the control system 110 can monitor one or more conditions of the discharge floor 106. For example, the discharge floor 106 can be monitored for fire, flooding, and/or other hazards using various sensors and detection techniques. The control system 110 can set the evacuation discharge floor of the second elevator group 92b to an alternate discharge floor 210 based on detecting one or more degraded conditions at the discharge floor 106. The alternate discharge floor 210 may have an alternate exit from the building 102. The control system 110 can restrict travel of the second elevator group 92b between the alternate discharge floor 210 and the discharge floor 106, for instance, to prevent the degraded conditions from spreading to the alternate discharge floor 210. Further, the multiple transfer floors 104a, 104b can enable changing the first evacuation discharge floor 206a of one or more elevator cars 23a-23c of the first elevator group 92a to a second evacuation discharge floor 206b at a secondary transfer floor 104b

While the above description has described the flow process of FIG. 5 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media (i.e., a computer program product), such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of operating a building elevator system, the method comprising:
determining that an evacuation call is active for an evacuation floor serviced by a first elevator group;
setting a transfer floor serviced by the first elevator group as an evacuation discharge floor of the first elevator group;
requesting a second elevator group to enter an evacuation mode of operation, the second elevator group operable to service the transfer floor and a discharge floor;
setting the transfer floor as the evacuation floor of the second elevator group; and
coordinating control of the first elevator group and the second elevator group to evacuate one or more occupants from the evacuation floor serviced by the first elevator group to the discharge floor serviced by the second elevator group.

2. The method of claim 1, wherein the evacuation floor serviced by the first elevator group is unreachable by the second elevator group.

3. The method of claim 1, wherein requesting the second elevator group to enter the evacuation mode of operation is performed based on determining that the first elevator group is inhibited from traveling to the discharge floor.

4. The method of claim 3, wherein determining that the first elevator group is inhibited from traveling to the discharge floor is based on detecting a degraded hoistway condition.

5. The method of claim 1, further comprising:
monitoring one or more conditions of the discharge floor;
setting the evacuation discharge floor of the second elevator group to an alternate discharge floor based on detecting one or more degraded conditions at the discharge floor; and
restricting travel of the second elevator group between the alternate discharge floor and the discharge floor.

6. The method of claim 1, further comprising:
changing the evacuation discharge floor of one or more elevator cars of the first elevator group to a secondary transfer floor.

7. The method of claim 1, wherein the evacuation mode of operation prioritizes travel between the transfer floor and the discharge floor over one or more requests received from one or more elevator call buttons between the transfer floor and the discharge.

8. A control system of a building elevator system, the control system comprising:
a processor; and
a memory comprising computer-executable instructions that, when executed by the processor, cause the processor to perform operations, the operations comprising:
determining that an evacuation call is active for an evacuation floor serviced by a first elevator group;
setting a transfer floor serviced by the first elevator group as an evacuation discharge floor of the first elevator group;
requesting a second elevator group to enter an evacuation mode of operation, the second elevator group operable to service the transfer floor and a discharge floor;
setting the transfer floor as the evacuation floor of the second elevator group; and
coordinating control of the first elevator group and the second elevator group to evacuate one or more occupants from the evacuation floor serviced by the first elevator group to the discharge floor serviced by the second elevator group.

9. The control system of claim 8, wherein the evacuation floor serviced by the first elevator group is unreachable by the second elevator group.

10. The control system of claim 8, wherein requesting the second elevator group to enter the evacuation mode of operation is performed based on determining that the first elevator group is inhibited from traveling to the discharge floor.

11. The control system of claim 10, wherein determining that the first elevator group is inhibited from traveling to the discharge floor is based on detecting a degraded hoistway condition.

12. The control system of claim 8, wherein the operations further comprise:
monitoring one or more conditions of the discharge floor;
setting the evacuation discharge floor of the second elevator group to an alternate discharge floor based on detecting one or more degraded conditions at the discharge floor; and
restricting travel of the second elevator group between the alternate discharge floor and the discharge floor.

13. The control system of claim 8, wherein the operations further comprise:
changing the evacuation discharge floor of one or more elevator cars of the first elevator group to a secondary transfer floor.

14. The control system of claim 8, wherein the evacuation mode of operation prioritizes travel between the transfer floor and the discharge floor over one or more requests received from one or more elevator call buttons between the transfer floor and the discharge.

15. A computer program product tangibly embodied on a computer readable medium, the computer program product including instructions that, when executed by a processor, cause the processor to perform operations comprising:
determining that an evacuation call is active for an evacuation floor serviced by a first elevator group;
setting a transfer floor serviced by the first elevator group as an evacuation discharge floor of the first elevator group;
requesting a second elevator group to enter an evacuation mode of operation, the second elevator group operable to service the transfer floor and a discharge floor;
setting the transfer floor as the evacuation floor of the second elevator group; and
coordinating control of the first elevator group and the second elevator group to evacuate one or more occupants from the evacuation floor serviced by the first elevator group to the discharge floor serviced by the second elevator group.

16. The computer program of claim 15, wherein requesting the second elevator group to enter the evacuation mode of operation is performed based on determining that the first elevator group is inhibited from traveling to the discharge floor.

17. The computer program of claim 16, wherein determining that the first elevator group is inhibited from traveling to the discharge floor is based on detecting a degraded hoistway condition.

18. The computer program of claim 15, wherein the operations further comprise:
monitoring one or more conditions of the discharge floor;
setting the evacuation discharge floor of the second elevator group to an alternate discharge floor based on detecting one or more degraded conditions at the discharge floor; and
restricting travel of the second elevator group between the alternate discharge floor and the discharge floor.

19. The computer program of claim 15, wherein the operations further comprise:
changing the evacuation discharge floor of one or more elevator cars of the first elevator group to a secondary transfer floor.

20. The computer program of claim 15, wherein the evacuation mode of operation prioritizes travel between the transfer floor and the discharge floor over one or more requests received from one or more elevator call buttons between the transfer floor and the discharge.
